(19) United States
(12) Patent Application Publication
(10) Pub. No.: US 2011/0005404 A1
(43) Pub. Date: Jan. 13, 2011

(54) GRILL CONVENIENT FOR STORAGE

(75) Inventor: Yaohui PAN, Fujian Province (CN)

Correspondence Address: RABIN & Berdo, PC, 1101 14TH STREET, NW, SUITE 500, WASHINGTON, DC, 20005, US

(73) Assignee: Tsann Kuen (Zhangzhou) Enterprise Co., Ltd., Fujian Province (CN)

(21) Appl. No.: 12/834,083

(22) Filed: Jul. 12, 2010

(30) Foreign Application Priority Data
Jul. 10, 2009 (CN) 200920306014.0

(51) Int. Cl. A47J 37/06

(52) U.S. Cl. 99/444

(57) ABSTRACT

An electric grill, more particularly, a grill convenient for storage is provided in the present invention. The present invention comprises: a main body, a pan for holding and cooking food disposed on said main body, two hand grips disposed on the left and right side of said pan, two moveable lock units respectively disposed on the left and right side of said body corresponding to said hand grips, and said lock units can lock up said pan or said hand grips. The pan and hand grips won't fall from the body when it is laid vertically. Furthermore, said main body comprises a first supporting bar and a lid provided with a second supporting bar; said first and second supporting bar define and form a supporting-plane on the center of gravity of the frontal side or rear side of said body and said body lid. In this way, the grill won't fall when it is vertically laid.

### FIELD OF INVENTION

The present invention relates to an electric grill, more particularly to a grill convenient for storage.

### BACKGROUND OF THE INVENTION

Ordinary electric grill comprises a pan for holding and cooking food, and hand grips disposed on the left and right of the pan, users can move the pan through the hand grips. Body is disposed beneath the pan to support the pan. As the pan and hand grips are isolated from the body, the electric grill can only be laid flat; if it is laid vertically, the pan and hand grips will easily fall from the body. Because of that, ordinary electric grill can't be stored vertically.

### SUMMARY OF THE INVENTION

The object of the present invention is to provide a grill convenient for storage which can be laid vertically, and the pan and hand grips won't fall from the body.

To achieve the above object, the present invention provides a grill convenient for storage, comprises: a main body; a pan disposed on said main body, two hand grips disposed on the left and right side of said pan respectively; two moveable lock units respectively disposed on the left and right side of said main body corresponding to said hand grips, wherein said lock units lock said pan or said hand grips. Thus, the pan and hand grips won't fall from the body when it is laid vertically.

According to a preferable embodiment, the lower part of said lock units hinged to said main body, and the upper part of said lock units clamp and connect to said pan or said hand grips. In this way, the lock units won't be lost, it's easy for users to button up or free the pan.

According to another preferable embodiment, wherein said main body further comprises: an upper cavity for holding said pan disposed on the upper part of said body, two side grooves for holding the corresponding hand grip disposed on the left and right side of said upper cavity respectively; two lower grooves disposed beneath said side grooves correspondently; wherein said lower grooves each comprises a hinge axis for clamping and connecting said lock units.

According to another preferable embodiment, said lower grooves each further comprises a location bar, and said lock units each comprises a location hook and a main hook; wherein said location hooks each clamps and connects to said location bars correspondently, and said main hooks each clamps and connects to said hand grips correspondently.

Further, a body lid is disposed beneath said body, wherein a supporting-plane is disposed on the center of gravity of the frontal side or rear side of said body and said body lid. In this way, the grill won't fall when it is vertically laid.

First supporting bar and said second supporting bar define and forma supporting-plane on the center of gravity of the front side or rear side of said main body and said lid. By adoption of the metallic supporting-bar to form the supporting-plane, the grill is durable.

The present invention, uses two lock units to button up the pan, in this way, the pan and hand grips won't fall from the body when it is laid vertically said main body further comprises a first supporting bar and a lid provided with a second supporting bar. In this way, the grill won't fall when it is vertically laid, thus storage room is saved.

### BRIEF DESCRIPTION OF DRAWINGS

FIG. 1 is a perspective view of an embodiment of the present invention, in which, the grill is laid flat and a buckle detach from the body.

FIG. 2 is a sectional view of the embodiment in FIG. 1 when the lock units button up the hand grips of the pan.

FIG. 3 is a perspective view of the embodiment in FIG. 1, in which, the grill is laid flat and the lock units button up the hand grips.

FIG. 4 is a perspective view of the embodiment in FIG. 1, in which, the grill is laid vertically and a buckle detach from the body.

FIG. 5 is a perspective view of the embodiment in FIG. 1, in which the grill is laid vertically and the lock units button up the hand grips.

### DESCRIPTION OF THE PREFERRED EMBODIMENTS

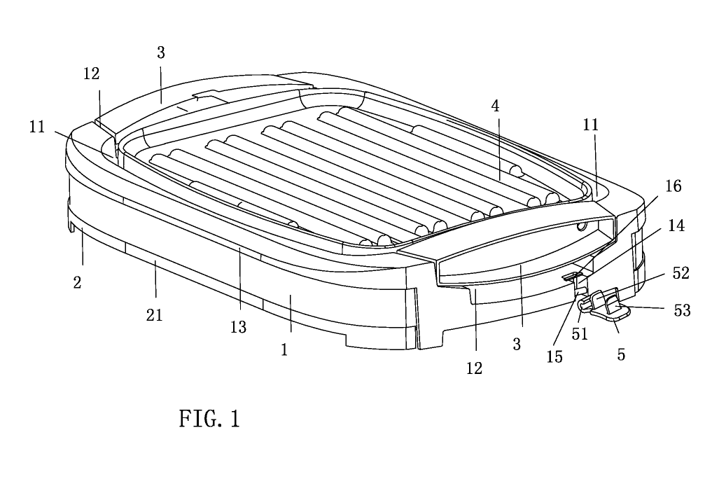

Referring to FIG. 1, it is a perspective view of an embodiment of the present invention, in which, the grill is laid flat and a buckle detach from the body. The grill, comprises an approximately rectangular body 1, a body lid 2, two hand grips 3, a pan 4 and two lock units 5.

An upper cavity 11 for holding pan 4 is disposed on the upper part of said body 1, wherein two stepped side grooves 12 for holding the corresponding hand grip 3 are disposed on the left and right of said upper cavity 11 respectively. Two lower grooves 14 are disposed beneath the corresponding side groove 12 on the left and right of said body 1. A hinge axis 15 is disposed on the lower part of each lower groove 14, and a location bar 16 is disposed on the upper part of each lower groove 14.

A body lid 2 with corresponding shape is disposed beneath said body 1. A supporting-plane is disposed on the center of gravity of the frontal side or rear side of said body 1 and said body lid 2. Said supporting-plane is determined by a bulgy metallic supporting-bar 21 disposed on said body lid 2 and a bulgy metallic supporting-bar 13 on said body 1.

Two hand grips 3 is screwed on the left and right sides of the pan 4 respectively, thus, the hand grips 3 and said pan 3 are integrated into one body. Two hand grips 3 both have inward-extending cavities on the outer fillet. Electric heating tubes are disposed in the pan 4, and several ribs are disposed on the upper face of the pan 4 for holding and cooking food.

An elbow 51 is disposed on the lower part of each buckle 5, and the elbow 51 is hinged on the hinge axis 15 on the lower groove 14 in the corresponding side of body 1. A location hook 52 is disposed on the middle of the buckle 5 and a main hook is disposed on the upper part of the buckle 5.

The grill works as follows: said pan 4 is laid in the upper cavity 11 of said body 1. Said hand grips 3 on the left and right of pan 4 are laid in the upper wider grooves of the side grooves 12 corresponding to the sides of body 1. The edge of the outer cavity of each hand grip is located more inside than the corresponding side of body 1. The lower narrow grooves of the side grooves 12 corresponding to the sides of body 1 is the space for finger to insert, so as to take or put down the hand grips 3 and the pan 4.

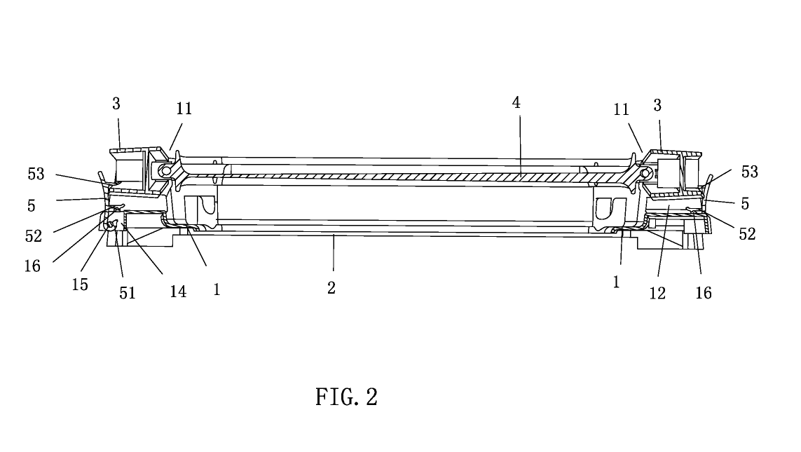

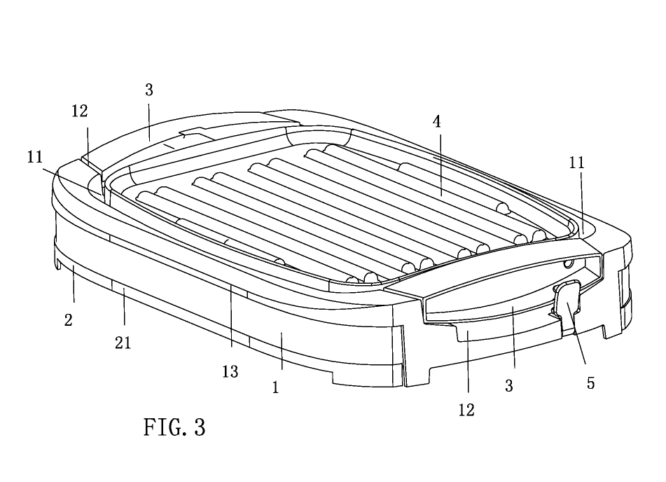

Referring to FIG. 2 and FIG. 3, the grill is stored as follows: turn up the lock units 5 on the left and right of the body 1, make the elbow 51 of each buckle 5 rotate around the hinge axis 15, and make the location hook 52 of each buckle 5 clamp-connect to the location bar on the upper part of corresponding lower groove 14 on the body 1, then, a clamping mechanism is formed. Wherein, the main hook 53 of each buckle 5 clamp-connect to the lower part of the pan 4 corresponding to the lower part of edge of the cavity of the hand grip 3. In this way, the two lock units 5 button up the hand grips 3, and make the body 1 and the pan 4 one body. The lock units and hand grips are approximately flush with the corresponding sides of the body, which makes the whole structure compact and beautiful.

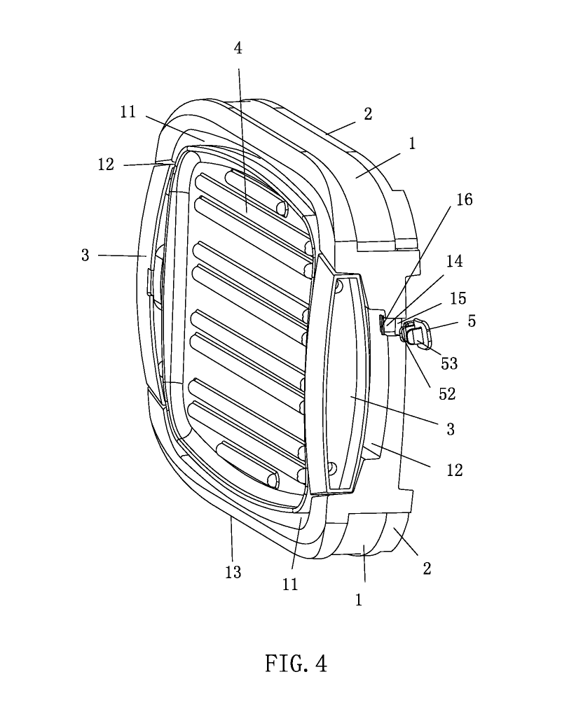

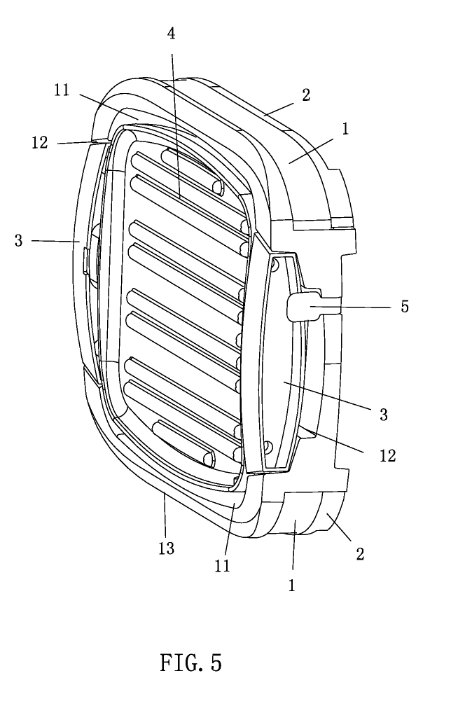

Turn the frontal sides of body 1 and the body lid 2 towards downside, and make the metallic supporting bar 21 on the body lid 2 and the metallic supporting bar 13 on the body 1 contact with the supporting plane, thus, the grill is erected. Referring to FIG. 4, two lock units detach from the corresponding hand grips 3, and the pan 4 easily fall from the body 1. Whereas, two lock units 5 button up the corresponding hand grips 3 on the pan 4, referring to FIG. 5, and the pan 4 won't fall from the body 1, thus, it's convenient for storage.

Of cause, the two lock units 5 can also directly button up the pan 4, and make the body 1 and the pan 4 a body, so as to store it vertically.

The described embodiments are to be considered in all respects only as illustrative and no restrictive. All changes which come within the meaning and range of equivalency of the claims are to be embraced with their scope.

What is claimed is:

1. A grill convenient for storage, comprises: a main body; a pan disposed on said main body; two hand grips disposed on the left and right side of said pan respectively; two moveable lock units respectively disposed on the left and right side of said main body corresponding to said hand grips; wherein said lock units lock said pan or said hand grips.

2. The grill convenient for storage according to claim 1, wherein the lower part of said lock units hinged to said main body, and the upper part of said lock units clamp and connect to said pan or said hand grips.

3. The grill convenient for storage according to claim 2, wherein said main body further comprises: an upper cavity for holding said pan disposed on the upper part of said body; two side grooves for holding the corresponding hand grip disposed on the left and right side of said upper cavity respectively; two lower grooves disposed beneath said side grooves correspondently; wherein said lower grooves each comprises a hinge axis for clamping and connecting said lock units.

4. The grill convenient for storage according to claim 3, wherein said lower grooves each further comprises a location bar, and said lock units each comprises a location hook and a main hook; wherein said location hooks each clamps and connects to said location bars correspondently, and said main hooks each clamps and connects to said hand grips correspondently.

5. The grill convenient for storage according to claim 1, wherein
said main body further comprises a first supporting bar and a lid provided with a second supporting bar.

6. The grill convenient for storage according to claim 5, wherein said first supporting bar and said second supporting bar define and form a supporting-plane on the center of gravity of the front side or rear side of said main body and said lid.
